(19) United States
(12) Patent Application Publication
(10) Pub. No.: US 2017/0233555 A1
(43) Pub. Date: Aug. 17, 2017

(54) Conteneur Oxo-biodegradable Antimicrobien

(71) Applicant: Cleanis, Paris (FR)

(72) Inventor: Luarent Helewa, Paris (FR)

(21) Appl. No.: 15/343,521

(22) Filed: Nov. 4, 2016

(30) Foreign Application Priority Data
Nov. 5, 2015 (FR) 1560612

(51) Int. Cl. C08K 13/02; A01N 59/06; B09B 3/00; B65D 85/00; B65F 1/00; A01N 55/02; B65D 81/30

(52) U.S. Cl. CPC C08K 13/02; A01N 55/02; A01N 59/06; B65D 81/30; B65D 85/70; B65F 1/0006; B09B 3/0075; C08K 2201/005; C08K 2201/018; B65F 2250/105

(57) ABSTRACT

An oxo-biodegradable antimicrobial receptacle for organic waste or waste from care activities which comprises a layer comprising low density polyethylene, an oxo-biodegradation additive at between 0.2 and 2.2% by weight and an antimicrobial additive at between 0.2 and 2.2% by weight, distributed in the polyethylene. It affords a period of preservation, in the dark, of at least 3 years, preferably 5 years, at a temperature not exceeding 30° C. The preservation is estimated by the carbonyl optical density resulting from the degradation of the polyethylene, measured according to the standard ISO 10640-2011 by FT-IR spectroscopy. The oxo-degradation is inhibited by the absence of light, and a period of degradation estimated by the carbonyl optical density of less than 2 years. The oxo-degradation additive does not promote Clostridium difficile spores.

### CROSS REFERENCE TO RELATED APPLICATION

This application claims priority to and the benefit of French Patent No. 1560612 filed in the French Intellectual Property Office on Nov. 5, 2015, the entire contents of which are incorporated herein by reference.

The present invention relates to the field of receptacles intended for the collection, transport, and secure elimination of organic waste, medical waste, waste from care activities, etc. More particularly, the invention targets the collection of waste from patients and from the care which is administered to them. In a known way, such waste was disposed of in plastic bags, especially based on polyethylene, ensuring leaktightness suitable for liquids according to patent EP 948304 from the Applicant. Nonetheless, there was a risk that microbes could proliferate on the surface of the bag, increasing the risks of contamination of the patient's environment. Polyethylene has a very long period of degradation.

The Applicant carried out research, aiming to conserve the liquid-tightness property afforded by the polyethylene, while benefiting from an antimicrobial action and an ability to rapidly degrade after a long period of storage, with preservation of the abovementioned properties. Firstly, the treatment of such waste by combustion is costly and special equipment is required. Secondly, offering an ability to rapidly degrade responds to a need identified by the Applicant. Thirdly, the ability to degrade gives rise to a difficulty in storing the receptacle before its use and incompatibility arises between rapid degradation during elimination and the antimicrobial action. Now, rapid degradation is a phenomenon involving bacteria, and this is what leads to the conflict between the aims.

Indeed, hygienic bags or receptacles are used in hospitals, doctors' surgeries and paramedical facilities, and retirement homes, to facilitate and secure the collection, transport and elimination of bodily fluids from patients, especially bedridden patients, and the associated organic waste. The increased demands in terms of hygiene, the battle against nosocomial diseases, the prevention of the proliferation of microorganisms responsible for infections and taking into account ecological and efficiency requirements have determined the research aims. The Applicant has developed a receptacle, generally a bag, which is oxo-biodegradable, suitable for good preservation before use, offering rapid degradation and a satisfactory antimicrobial effect. These aims are contradictory in and of themselves.

The invention makes it possible to ensure sufficient storage in the dark, rapid oxo-biodegradation during elimination following use, all while avoiding the proliferation of pathogenic microorganisms.

The oxo-biodegradable receptacle according to the invention is intended for organic waste or waste from care activities. The oxo-biodegradable receptacle comprises a layer comprising low density polyethylene, an oxo-biodegradation additive at between 0.2 and 2.2% by weight and an antimicrobial additive at between 0.2 and 2.2% by weight, distributed in the polyethylene, affording a period of preservation, in the dark, of at least 3 years, preferably 5 years, at a temperature not exceeding 30° C. The preservation is estimated by the carbonyl optical density resulting from the degradation of the polyethylene, measured according to the standard ISO 10640-2011 by FT-IR spectroscopy. The oxo-degradation is inhibited by the absence of light. The period of oxo-biodegradation estimated by the carbonyl optical density, said period being less than 2 years. The oxo-degradation additive does not promote Clostridium difficile spores.

The oxo-biodegradable receptacle can thus be stored for several years before being used. Oxo-degradation is accelerated by exposure to UV radiation and to a high temperature under standard conditions of use of said oxo-biodegradable receptacle, especially in the presence of oxygen. The oxo-biodegradation period enables the bio-degradation of said oxo-biodegradable receptacle, which proves to be an environmentally-friendly and economical way of treating this type of waste. The oxo-biodegradation additive is selected to not have an effect on Clostridium difficile spores, in order to avoid promoting them. A high degree of security from pathogenic microorganisms is therefore obtained.

In one embodiment, the oxo-biodegradation additive comprises a metal salt and a temporary antioxidant. The metal salt is chosen from manganese, cobalt and iron stearate. The temporary antioxidant is active for at least 3 years in the dark and at a temperature not exceeding 30°. The temporary antioxidant is preferably active for at least 5 years. The temporary antioxidant preferably comprises manganese.

In one embodiment, the period of degradation is less than 18 months.

In one embodiment, the antimicrobial additive comprises zinc and zeolites. Zeolites offer an excellent zinc storage capacity. Zinc is an effective and biocompatible antibacterial agent.

In one embodiment, the zeolites are chosen from the heulandites. The heulandites may be coated in polyethylene.

The antimicrobial additive preferably comprises at least 5% zinc pyrithione. Zinc pyrithione is biocompatible, biotolerant, antifungal and antibacterial. Moreover, zinc pyrithione has good resistance to thermal ageing and also to UV exposure.

In one embodiment, the zeolites are charged with a mineral antimicrobial component, preferably zinc.

In one embodiment, the zeolites are coated in polyethylene. The zeolites may be incorporated in the polyethylene matrix.

In one embodiment, the zeolites have a particle size of between 0.5 and 1.0 μm, said layer having a thickness of at least 3.0 μm.

In one embodiment, the period of preservation, in the dark, estimated by the carbonyl optical density, is at least 5 years. The ageing test may be carried out with a Nicolet Is10IR-TS spectrometer. An accelerated thermal ageing test may be carried out with a Memmert UFE600 ventilated oven at temperatures of 60° and 70° in accordance with standard ASTM D5510, the period of preservation being confirmed by a test period, during which the absence of significant signs of degradation of the substance is observed.

In one embodiment, the antimicrobial additive is active against 51 microorganisms, including Escherichia coli, Salmonella, Listeria, Pseudomonas, Aspergillus Niger, Aspergillus amstelodami, Aspergillus nidulans, Candida albicans, Clostridium difficile, Corynebacterium spp, Corynebacterium minutissimum, Enterobacter gergoviae, Klebsiella pneumoniae, Listeria monocytogenes, Mesophilic aerobes, Methicillin Resistant Staphylococcus aureus (MRSA), Mucor racemosus, M.thermophile, Penicillium chrysogenum, Proteus mirabilis, Proteus vulgaris, Pseudomonas aeruginosa, Pseudomonas cepacia, Pseudomonas putida, Saccharomyces cerevisiae, Salmonella enteritidis, Staphylococcus aureus, Trichophyton mentagrophytes and the spores of Clostridium difficile.

In one embodiment, a plurality of identical receptacles are packaged in an opaque box. The opaque box ensures protection from light and enables preservation of said oxo-biodegradable receptacles before use. Thus, during the step of preservation of the receptacle, the polyethylene degradation bacteria remain either absent, especially the bacteria present in the soil, for example Rhodococcus rhodochrous, or inactive, especially due to the absence of light, to the temperature, which where possible does not exceed 30°, and to the oxo-degradation additive provided with at least one antioxidant.

In one embodiment, the oxo-degradation additive comprises two antioxidants ensuring a function of stabilizing the polyethylene. Oxo-biodegradation is degradation identified as resulting from oxidative phenomena and using bacteria. The oxidative and bacterial phenomena are simultaneous or successive. Degradation accelerates during exposure to heat and/or to light. Subsequently, the degradation continues, even if the receptacle is in the dark, for example buried. The receptacle may thus be satisfactorily degraded.

The oxo-biodegradation additive may comprise a metal salt, more particularly a transition metal salt which promotes oxidation, a primary antioxidant which makes it possible to avoid premature oxidation of the polyethylene during the production of the receptacle, in particular during extrusion/injection, due to the temperature reached during extrusion/injection, a high temperature being one of the factors which accelerates the process of oxo-biodegradation, and a secondary antioxidant which temporarily stabilizes and neutralizes the oxidative process of creation of free radicals in the polyethylene. The receptacles thus obtained are oxo-biodegradable, bioassimilable, recyclable and may optionally be incinerated. The receptacles have an antimicrobial activity which is effective on more than 50 microorganisms, according to standards ISO22196 and JIS Z 2801, and also effective on Clostridium difficile spores according to a method adapted from standard ISO22196. An adaptation is, for example, useful for Clostridium difficile, which is cultured anaerobically. To this end, an anaerobic system is employed.

The receptacle thus affords excellent protection against nosocomial infections, cross-contamination, stains and the development of odors.

In one particular embodiment, the oxo-biodegradable receptacle predominantly comprises low density polyethylene, CAS no. 9002-88-4. The antimicrobial additive is incorporated into the polyethylene when the receptacle is manufactured. The antimicrobial additive comprises an active substance based on zinc, CAS no.13463-41-7. More specifically, the antimicrobial additive may contain 1-hydroxypyridine-2-thione zinc. An inert filler may also be included in the composition of the receptacle, for example calcium carbonate.

In one embodiment, the oxo-biodegradation additive is included at 1 and 2.2% by weight.

In one embodiment, the antimicrobial additive is included at 1 and 2.2% by weight.

The oxo-biodegradation additive also comprises a temporary antioxidant, for example a phenolic antioxidant. The phenolic antioxidant may be of chemical formula C₇₃H₁₀₈O₁₂. The phenolic antioxidant may be an Irganox 1010, a Richnox 1010 or else Evernox 10.

The biodegradability of a substance depends on its molecular chemical structure. A material is considered to be biodegradable if the degradation which transforms the material into water, carbon dioxide, methane or biomass is due to the action of microorganisms such as bacteria and fungi.

Biodegradability in and of itself is not the subject of a standard, but standards ISO 14855 and ISO 14852 relate to the evaluation of biodegradability by measuring the emission of CO₂ and oxygen consumption.

The Applicant carried out stability tests under normal storage conditions.

The period of preservation of the test sample is confirmed by a test period in which the properties of the material are significantly preserved. The test was carried out on a (white coloured) PEBD bag with a thickness of 33.7 μm. The results are reported with the carbonyl optical density on the y axis and the period of accelerated ageing in hours on the x axis. The test consists in subjecting a specimen to an accelerated thermal ageing. It makes it possible to verify the stability of the specimen under storage conditions and over the course of its working lifetime; see the table below and FIG. 1.

Accelerated thermal ageing
Carbonyl optical density (absorbance) over the course of the accelerated thermal ageing test

| | Carbonyl optical density (1714 cm⁻¹) | | | | | | | | | | |
|---|---|---|---|---|---|---|---|---|---|---|---|
| Specimen | 0 h | 96 h | 190 h | 264 h | 361 h | 436 h | 576 h | 698 h | 768 h | 862 h | 936 h |
| Cleanis | 0.0000 | −0.0001 | −0.0001 | 0.0000 | 0.0000 | 0.0001 | 0.0001 | 0.0002 | 0.0000 | 0.0001 | 0.0002 |
| | Carbonyl optical density (1714 cm⁻¹) | | | | | | | | | | |
| Specimen | 1032 h | 1109 h | 1223 h | 1277 h | 1368 h | 1540 h | 1704 h | 1872 h | 2043 h | 2115 h | 2903 h |
| Cleanis | 0.0001 | 0.0000 | 0.0001 | 0.0001 | 0.0002 | 0.0002 | 0.0002 | 0.0006 | 1.0010 | 0.0018 | 0.0343 |

The test specimen of material of the receptacle showed an initial period of stability followed by a significant increase in the measurement of carbonyl optical density after 1872 test hours. This result indicates that the specimen underwent degradation. This is confirmed by visual observation of the final appearance of the specimen after the test. The initial period of stability confirms that the test specimen is initially stable to thermal ageing. The product has the requisite working lifetime under storage conditions protected from prolonged exposure to UV radiation and at a mean temperature not exceeding 30° C.

According to the methodology provided in Afnor AC T51-808, exposure at 70° for 320 hours may be likened to exposure for a year at 30° . Consequently, the absence of degradations observed in the specimen of the receptacle with thermal ageing up to 1872 test hours at 70° ensures a preservation of at least five years under storage conditions with a temperature of less than or equal to 30°.

An accelerated ageing test under UV radiation was carried out. The test simulates the degradation of the material over the course of its exposure to the environment and in particular the effect of light on the plastic. The degradation of the specimen is evaluated after prolonged exposure to light, simulating being discarded in nature.

Throughout the test, the specimen containing the oxo-biodegradation additive showed a significant increase in the carbonyl optical density. This observation is confirmed by the visual observation of the specimens at the end of the UV ageing cycle: the test specimen shows signs of physical weakening while the control specimen remains largely intact.

The observation of advanced degradation in the test specimen is in keeping with the oxo-biodegradation additive, which promotes the degradation of the product during prolonged exposure to the sun.

The temporary antioxidant is consumed slowly during storage and may be rapidly destroyed by sunlight and exposed during use or as waste.

At the end of the test, the receptacle specimen has visible signs of physical weakening. The prolonged exposure to the sun causes degradation of the receptacle. The results are reported with the carbonyl optical density on the y axis and the period of accelerated ageing in hours on the x axis; see the table below and FIG. 2.

Accelerated UV ageing
Carbonyl optical density (absorbance) over the course of the accelerated UV ageing test

| | Carbonyl optical density (1714 cm⁻¹) | | | | | | | |
|---|---|---|---|---|---|---|---|---|
| Specimen | 0 h | 48 h | 96 h | 170 h | 218 h | 266 h | 338 h | 386 h |
| Cleanis | 0.0000 | 0.0000 | 0.0011 | 0.0033 | 0.0052 | 0.0076 | 0.0115 | 0.00142 |

A successive UV radiation/thermal accelerated ageing test was carried out.

This test simulates the ageing of the material exposed to the environment. The degradation of the specimen is evaluated in the environment in the absence of light. It makes it possible to evaluate the degradation of the product at the end of its working lifetime or in the environment when it is disposed of as waste in the absence of light after a preliminary exposure to UV radiation.

After initial exposure to UV radiation for 100 hours, no significant sign of degradation was observed. Once transferred to the oven for accelerated thermal ageing, the specimen showed a significant increase in the measurement of carbonyl optical density, which increased during the rest of the test. This indicates that the test specimen has undergone significant degradation, see table below and FIG. 3.

UV/thermal accelerated ageing
Carbonyl optical density (absorbance) over the course of the successive
UV radiation and thermal accelerated ageing tests

| | Carbonyl optical density (1714 cm⁻¹) | | | | | | | |
|---|---|---|---|---|---|---|---|---|
| | UV | | | | | Thermal | | |
| Specimen | 0 h | 24 h | 48 h | 72 h | 100 h | 190 h | 264 h | 360 h |
| Cleanis | 0.0000 | 0.0000 | 0.0001 | 0.0005 | 0.0013 | 0.0066 | 0.0120 | 0.0186 |

The Applicant carried out tests on specimens containing 1% by weight of oxo-biodegradation additive and 1% by weight of antimicrobial additive.

An accelerated thermal ageing test simulates the change in the degradation of the specimen during storage, especially away from UV radiation. It makes it possible to verify the stability of the specimen under storage conditions and over the course of its working lifetime.

The film containing the additives and the control specimens did not show a significant increase in the carbonyl optical density at the end of the test. This indicates that the specimens were not subjected to significant degradation. The absence of degradation confirms the stability to thermal ageing. These results are confirmed by visual observation of the samples: at the end of the test, the two specimens are intact; see the table below and FIG. 4.

Accelerated thermal ageing
Carbonyl optical density (absorbance) over the course of
the accelerated thermal ageing test

| | Carbonyl optical density (1714 cm⁻¹) | | | | | | |
|---|---|---|---|---|---|---|---|
| Specimen | 0 h | 96 h | 192 h | 288 h | 384 h | 480 h | 576 h |
| Cleanis test specimen | 0.0000 | 0.0001 | 0.0001 | 0.0000 | 0.0001 | 0.0001 | 0.0002 |
| Control specimen | 0.0000 | 0.0001 | 0.0001 | 0.0002 | 0.0001 | 0.0001 | 0.0000 |

An accelerated UV ageing test simulates the degradation of the material over the course of its exposure to the environment and in particular the effect of light on the plastic. It makes it possible to evaluate the degradation of the specimen after prolonged exposure to light, when the specimen is discarded in nature.

The specimen containing the additives underwent greater degradation than that of the control specimen. A greater change in carbonyl absorbance than the control specimen at the end of the test is demonstrated. This result proves that the sample containing the pro-degrading and antimicrobial additives is in a more advanced state of degradation.

Indeed, the latter reached a value of 0.0101 for carbonyl absorbance after 672 test hours, indicating that it reached a degree of weakening equivalent to a reduction in the elongation at break of greater than 95%, whereas the control specimen only demonstrated an increase of 0.0066 for carbonyl absorbance. The oxo-biodegradation additive promotes degradation of the PEBD film. Including the antimicrobial additive has no measureable effect on the action of the oxo-biodegradation additive; see the table below and FIG. 5. This result is confirmed by the final visual appearance of the specimens: the test specimen shows greater signs of degradation than the control specimen.

Accelerated UV ageing
Carbonyl optical density (absorbance) over the course of the accelerated UV ageing test

| | Carbonyl optical density (1714 cm⁻¹) | | | | | | | |
|---|---|---|---|---|---|---|---|---|
| Specimen | 0 h | 48 h | 96 h | 144 h | 192 h | 240 h | 288 h | 336 h |
| Cleanis test | 0.0000 | 0.0000 | 0.0003 | 0.0008 | 0.0012 | 0.0017 | 0.0025 | 0.0032 |
| specimen | | | | | | | | |
| Control | 0.0000 | 0.0000 | 0.0002 | 0.0004 | 0.0006 | 0.0008 | 0.0015 | 0.0017 |
| specimen | | | | | | | | |

| | Carbonyl optical density (1714 cm⁻¹) | | | | | | |
|---|---|---|---|---|---|---|---|
| Specimen | 384 h | 432 h | 48 h | 528 h | 576 h | 624 h | 672 h |
| Cleanis test | 0.0039 | 0.0051 | 0.0061 | 0.0070 | 0.0077 | 0.0090 | 0.0101 |
| specimen | | | | | | | |
| Control | 0.0021 | 0.0029 | 0.0035 | 0.0040 | 0.0046 | 0.0055 | 0.0066 |
| specimen | | | | | | | |

A successive UV radiation/thermal accelerated ageing test simulates the ageing of the material which has been exposed to the environment. The degradation of the specimen is evaluated in the environment in the absence of light. The test makes it possible to evaluate the degradation of the product at the end of its working lifetime or in the environment when it is disposed of as waste in the absence of light after a preliminary exposure to UV radiation.

The results, as shown in the table below and FIG. 6, demonstrate that the test specimen underwent significantly greater degradation than the control specimen. The change in carbonyl absorbance is greater than the control specimen at the end of the test. The specimen containing the additives is in a more advanced state of degradation. Indeed, the specimen reached a value of 0.0100 for carbonyl absorbance after 336 test hours (including the 48 hours of UV pre-ageing), indicating that it reached a degree of weakening equivalent to a reduction in the elongation at break of greater than 95%, whereas the control specimen demonstrated no significant increase for carbonyl absorbance. These observations demonstrate that the oxo-biodegradation additive promotes degradation of the PEBD film. Including the antimicrobial additive does not seem to have a measureable effect on the action of the pro-degrading catalyst. This result is confirmed by the final visual appearance of the specimens: the test specimen shows signs of degradation whereas the control specimen remains intact.

UV/thermal accelerated ageing
Carbonyl optical density (absorbance) over the course of the
successive UV radiation and thermal accelerated ageing tests

| | Carbonyl optical density (1714 cm⁻¹) | | | | |
|---|---|---|---|---|---|
| | UV | | Thermal | | |
| Specimen | 0 h | 48 h | 144 h | 240 h | 336 h |
| Cleanis test | 0.0000 | 0.0003 | 0.0027 | 0.0055 | 0.0100 |
| specimen | | | | | |
| Control | 0.0000 | 0.0000 | 0.0001 | 0.0000 | 0.0000 |
| specimen | | | | | |

Moreover, the Applicant carried out tests on Clostridium difficile which is a particularly worrisome bacterium in the hospital and public health domain. This bacterium is present in the vegetative form or in the form of spores. Sporicidal activity tests on the oxo-biodegradable receptacle were carried out using the method ISO22196, apart from a technical modification associated with the use of an anaerobic system specific to Clostridium difficile. The oxo-biodegradable receptacle comprises a PEBD film containing 1% by weight of oxo-biodegradation additive and 1% by weight of antimicrobial additive.

| | | | | Number of CFU* | |
|---|---|---|---|---|---|
| | | | Number of | after 24 h of | |
| | | | CFU* | exposure to the | Logarithmic |
| Appearance | Specimen reference | Formulation | innoculated | microbial culture | reduction** |
| Transparent | PEBD film with | Blank control - 0 h | 5.2 × 10⁵ | -NA- | Non applicable |
| | Cleanis oxo- | Blank control without | 5.2 × 10⁵ | 9.6 × 10⁵ | |
| | biodegradable | covering film - 24 h | | | |
| | additive-untreated | Blank test 1 - 24 h | 5.2 × 10⁵ | 1.4 × 10⁶ | |
| | | Blank test 2 - 24 h | 5.2 × 10⁵ | 1.0 × 10⁵ | |
| | | Blank test 3 - 24 h | 5.2 × 10⁵ | 1.7 × 10⁵ | |
| Transparent | PEBD film with | Test 1 | 1.4 × 10⁶ | 1.0 × 10⁰ | 6.1 |
| | Cleanis oxo- | Test 2 | 1.0 × 10⁵ | 1.0 × 10⁰ | 5.0 |
| | biodegradable and | Test 3 | 1.7 × 10⁵ | 1.0 × 10⁰ | 5.2 |
| | antimicrobial | | | | |
| | additives - treated | | | | |

| | | |
|---|---|---|
| Adjustment (Total Viable Organisms) | 1.3 × 10⁶ | - Not Applicable - |

*Colony-Forming Units
**Logarithmic reduction = Log(number of CFU untreated blank control 24 h) − Log(number of CFU treated specimen 24 h)
Result:
Under test conditions, the PEBD film containing the oxo-biodegradable and antimicrobial additives reduces the number of Clostridium difficile spores by more than 3 log (99.99%), demonstrating significant sporicidal activity.

Under test conditions, the receptacle reduces the number of Clostridium difficile spores by more than 99.99%.

### BRIEF DESCRIPTION OF THE DRAWINGS

A full and enabling disclosure of the subject matter, including the best mode thereof, directed to one of ordinary skill in the art, is set forth more particularly in the remainder of the specification, which makes reference to the appended figures in which:

FIG. 1 graphically illustrates the effects on carbonyl optical density (1714 cm⁻¹) over the course of the accelerated thermal ageing test;

FIG. 2 graphically illustrates the effects on carbonyl optical density (1714 cm⁻¹) over the course of the accelerated UV ageing test;

FIG. 3 graphically illustrates the effects on carbonyl optical density (1714 cm⁻¹) over the course of the successive UV radiation and thermal accelerated ageing tests;

FIG. 4 graphically illustrates the effects on carbonyl optical density (1714 cm⁻¹) over the course of the accelerated thermal ageing test with test and control specimens;

FIG. 5 graphically illustrates the effects on carbonyl optical density (1714 cm⁻¹) over the course of the accelerated UV ageing test with test and control specimens;

FIG. 6 graphically illustrates the effects on carbonyl optical density (1714 cm⁻¹) over the course of the successive UV radiation and thermal accelerated ageing tests with test and control specimens.

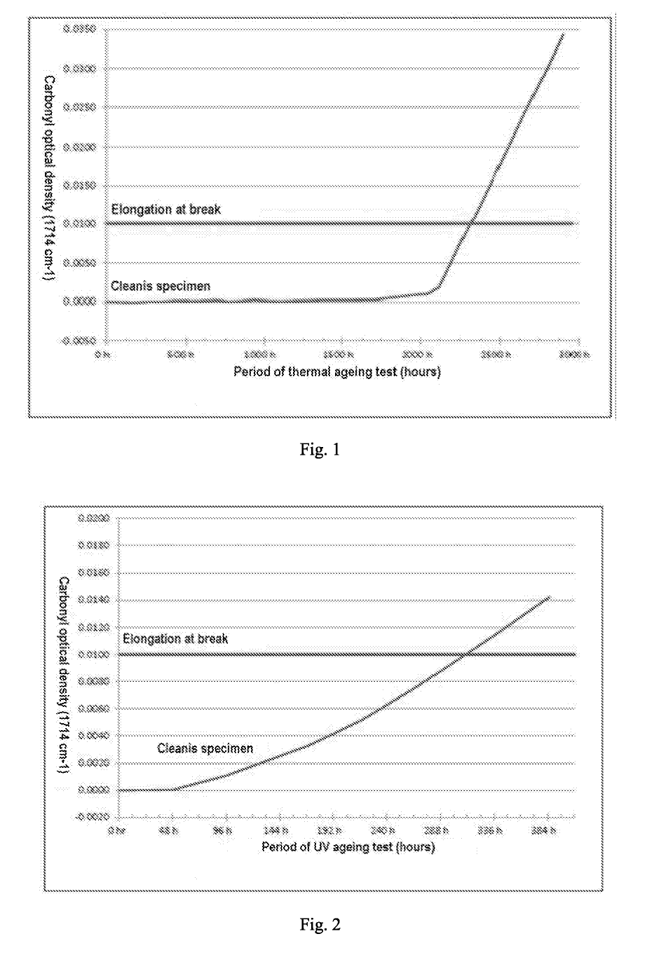

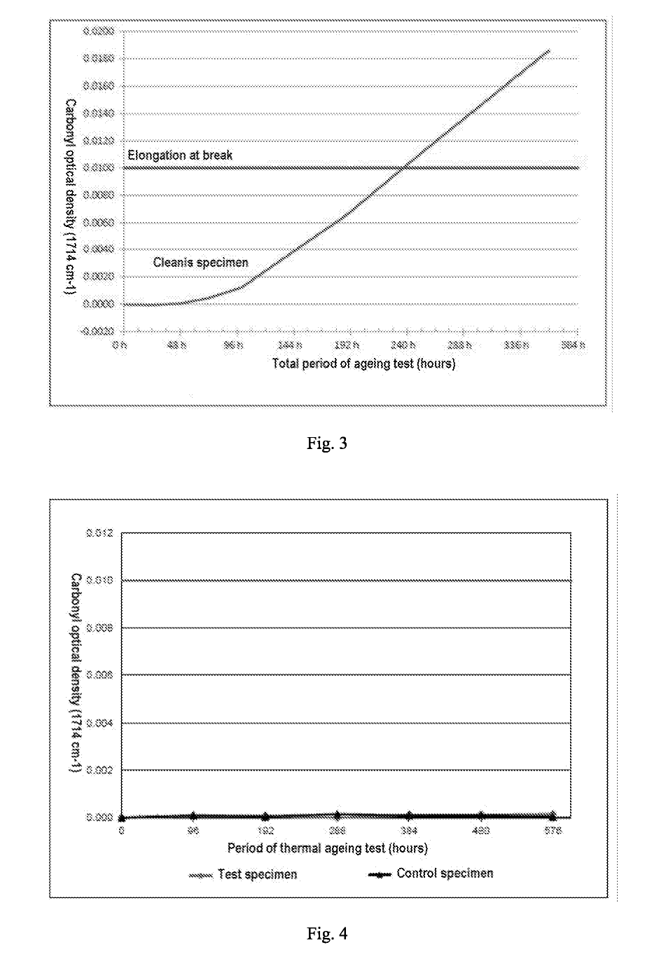

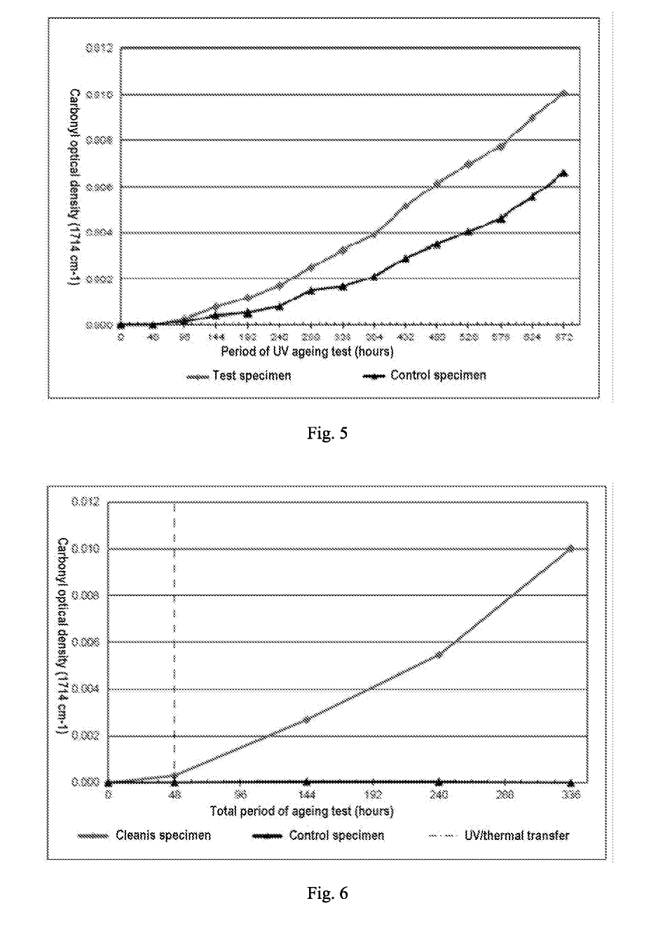

1. Oxo-biodegradable antimicrobial receptacle for organic waste or waste from care activities, comprising a layer comprising low density polyethylene, an oxo-biodegradation additive at between 0,2 and 2.2% by weight and an antimicrobial additive at between 0.2 and 2.2% by weight, distributed in the polyethylene, affording a period of preservation, in the dark, of at least 3 years, at a temperature not exceeding 30° C., the preservation being estimated by the carbonyl optical density resulting from the degradation of the polyethylene, measured according to the standard ISO 10640 -2011 by FT-IR spectroscopy, the oxo-degradation being inhibited by the absence of light, and a period of degradation estimated by the carbonyl optical density of less than 2 years, the oxo-degradation additive not promoting Clostridium difficile spores.

2. Receptacle according to claim 1, in which the oxo-biodegradation additive comprises a metal salt comprising manganese, cobalt, iron stearate, or a combination thereof and a temporary antioxidant, active for at least 3 years, in the dark and at a temperature not exceeding 30° C.

3. Receptacle according to claim 1, in which the period of degradation is less than 18 months.

4. Receptacle according to claim 1, in which the antimicrobial additive comprises zinc and a zeolite.

5. Receptacle according to claim 4, in which the antimicrobial additive comprises at least 5% zinc pyrithione.

6. Receptacle according to claim 4, in which the zeolite is charged with a mineral antimicrobial component.

7. Receptacle according to claim 4, in which the zeolite is coated in PE.

8. Receptacle according to claim 4, in which the zeolite have has a particle size of between 0.5 and 1 μm, the layer having a thickness of at least 3 μm.

9. Receptacle according to claim 1, in which the period of preservation, in the dark, estimated by the carbonyl optical density, is at least 5 years.

10. Receptacle according to claim 1, in which the antimicrobial additive is active against Escherichia coil, Salmonella, Listeria, Pseudomonas, Aspergillus Niger, Aspergillus amstelodami, Aspergillus nidulans, Candida albicans, Clostridium difficile, Corynebacterium spp, Corynebacterium minutissimum, Enterobacter gergoviae, Klebsiella pneumoniae, Listeria monocytogenes, Mesophilic aerobes, Methicillin Resistant Staphylococcus aureus (MRSA), Mucor racemosus, M. thermophile, Penicillium chrysogenum, Proteus mirabilis, Proteus vulgaris, Pseudomonas aeruginosa, Pseudomonas cepacia, Pseudomonas putida, Saccharomyces cerevisiae, Salmonella enteritidis, Staphylococcus aureus, Trichophyton mentagrophytes and the spores of Clostridium difficile.

11. Receptacle according to claim 1, in which a plurality of identical receptacles are packaged in an opaque box.

12. Receptacle according to claim 1, in which the oxo-biodegradation additive comprises manganese,

13. Receptacle according to claim 4, in which the antimicrobial additive comprises zinc and heulandites.

14. Receptacle according to claim 6, in which the mineral antimicrobial component is zinc.
